(19) United States
(12) Patent Application Publication
(10) Pub. No.: US 2026/0335936 A1
(43) Pub. Date: Oct. 29, 2026

(54) SMART DEVICE WITH OPTICAL DUAL-MODE SENSING MODULE ARRAY

(71) Applicant: Pade Technology Co., Ltd., Taoyuan City (TW)

(72) Inventor: Jen-Jie CHIEH, Taoyuan City (TW)

(21) Appl. No.: 19/659,372

(22) Filed: Apr. 27, 2026

(30) Foreign Application Priority Data
Apr. 28, 2025 (TW) 114116016

(51) Int. Cl. B07C 5/342; B07C 5/36; G01N 21/25; G06V 10/14; G06V 20/50; G06V 20/60

(52) U.S. Cl. CPC B07C 5/3422; B07C 5/362; G01N 21/255; G06V 10/14; G06V 20/50; G06V 20/60

(57) ABSTRACT

A smart device with optical dual-mode sensing module array for identifying a textile article main part of a textile article, thereby generating a selection signal, and selecting the textile article main part to a predetermined storage position according to the selection signal. The smart device with optical dual-mode sensing module array includes: a conveyor module, a sensing module array, a selection module and a control center, the control center is coupled to the conveyor module, the sensing module array and the selection module. The sensing module array is formed of multiple sensing modules, each of the sensing modules has an image identification module and/or a spectrum identification module, thereby forming an optical dual-mode sensing module. The image identification module is capable of identifying a type of the textile article main part of the textile article and positional information of the textile article, thereby improving accuracy of identification.

### BACKGROUND OF THE INVENTION

### (a) Field of the Invention

The present invention relates to a smart device, the smart device has a sensing module array which is formed of multiple sensing modules, each of the sensing modules has an image identification module and/or a spectrum identification module, so as to form an optical dual-mode sensing module, the smart device further includes a conveyor module, a selection module and/or a cutting module, the smart device does not require manual identification and selection on the textile article, nor does it require manual cutting on each of the accessories, therefore, the smart device is capable of improving accuracy of identification, selection and recovery, and is a smart device having an optical dual-mode sensing module array.

### (b) Description of the Prior Art

As the technology advances and the living standard and quality improve, many common daily life items are not sold in their conventional forms, and the consumers have much more choices in shopping, particularly when shopping for apparel items. Since humans are visual-oriented animals, in addition to how it feels upon wearing clothes, how the clothes looks, and how it attracts attention from others upon wearing are also very important. As a result, people continue to buy new clothes along with changes in various fashion trends, and discard, give away or recycle old clothes which they deem old-fashioned.

Some of the recycled clothes are made into products in other industries or new textile materials, and some are given to people who need them. Therefore, after recycling old clothes, the old clothes need to be classified according to different types and materials, so as to perform other subsequent processing on the old clothes. However, the recycled volume of the current clothes is massive, and consequently requiring massive amounts of labor and time on performing classifications on the clothes.

Taiwanese Invention Patent Publication No. I854714 (referred to hereafter as Reference 1) discloses an “INTELLIGENT RECOVERY DEVICE WITH CLOTHES IDENTIFICATION AND A MOVABLE BOX”, which uses a scanner to read the bar code of a piece of clothing to perform clothes identification, and then places the clothes into a box, however, the bar code of old clothes or defected clothes may have been damaged or have become non-existent, and thus Reference 1 is not applicable to all clothes and the accuracy of identifications thereof are dubious. Moreover, since the box is movable, its volume must be limited, thus making it impossible to process clothes rapidly at a large number. Taiwanese Utility Model Patent Publication No. M658012 (referred to hereafter as Reference 2) discloses a “USED CLOTHES RECYCLING SYSTEM”, which uses a spectrometer to perform identification on clothes materials, and then places the clothes into a box. Although Reference 2 seems to have solved the identification problem in Reference 1, Reference 2 can only identify clothes in batches and a box is still required, thus making it impossible to process clothes rapidly at a large number, just the same as that in Reference 1. Taiwanese Utility Model Patent Publication No. M650068 (referred to hereafter as Reference 3) discloses an “INTELLIGENT IDENTIFICATION AND RECYCLING SYSTEM”, which

also uses a spectrometer to perform identification on clothes materials, and then uses an air-in and air-out unit to blow clothes into a corresponding classification channel. Although Reference 3 solves a part of the problems in Reference 1 and Reference 2, Reference 3 can also only identify the clothes in batches, and in fact, Reference 3 employs air flows, thus making it necessary to switch between opening/closing of a feeding valve and a distribution valve, so as to avoid turbulences in air flows that leads to the clothes being fed into incorrect distribution valves. Thus, Reference 3 still has the problem of being incapable of processing clothes rapidly at a large number, and the internal part of the system of Reference 3 is prone to generation of unexpected turbulences, which affects the accuracy of selections.

Clothes belongs to textile articles, and a piece of clothing is usually formed of a clothes main part and accessories configured thereon, and the accessories, for instance, the shape, the material and the property of a button or zipper are very different from those of the clothes main part. For example, the clothes main part is formed of natural fibers or synthetic fibers, and yet the accessories are usually formed of metal or plastic parts. Moreover, a clothes main part in a piece of clothing usually makes up the majority of surface area or volume of the piece of clothing, but an accessory which makes up only a very small part of surface area or volume thereof often causes great difficulty in subsequent recovery processing procedures. For instance, upon melting the synthetic fibers in a piece of clothing for re-making, if accessories are not firstly cut away from the clothes main part, the plastic material of an accessory button would cause equipment being clogged up, due to the button not being completely turned into a melt because the button has a different melting point. References 1 to 3 only perform identification and selection on clothes, but do not address the aforementioned difficulties encountered in further recovery of clothes.

Therefore, upon processing a large number of clothes, such as used clothes delivered by container shipping, it is absolutely necessary to have a device capable of continuously and accurately identifying, selecting and recovering clothes rapidly at a large number.

### SUMMARY OF THE INVENTION

In light of the above-mentioned problems, based on years of practical experiences and ample professional knowledge, the inventor has invented a smart device, the smart device has a sensing module array formed of multiple sensing modules, each of the sensing modules has an image identification module and/or a spectrum identification module, so as to form an optical dual-mode sensing module, the image identification module is capable of identifying a type (such as towels, clothes, pants, skirts, etc.) of a textile article main part of a textile article and/or marking accessory positioning on the textile article main part for various accessories (such as buttons and zippers, etc.) configured on the textile article main part, the spectrum identification module is capable of identifying a material of the textile article main part and/or a material of the accessory, thereby improving identification accuracy; the smart device further includes a conveyor module, a selection module and/or a cutting module, wherein the conveyor module (such as a conveyor belt) continuously transports a plurality of the textile articles respectively from a starting point towards a destination, the selection module (such as a mechanical arm) selects the textile article to a predetermined position according to the type and/or material of the textile article main part, thereby improving selection accuracy, the cutting module cuts the accessory away from the textile article main part according to the accessory positioning of the various accessories in the textile article, so as to perform subsequent recovery processing, and the textile article main part, having the accessory cut away, is more suitable for entering into a subsequent recovery system, thereby improving recovery accuracy. Accordingly, the smart device does not require manual identification and selection on the textile article, nor does it require manual cutting on each accessory, therefore, the smart device is capable of improving accuracy of identification, selection and recovery, and is a smart device having an optical dual-mode sensing module array.

On the basis of at least an object of the present invention, the present invention provides a smart device with optical dual-mode sensing module array, used for identifying a textile article main part of a textile article, so as to generate a selection signal, and then select the textile article main part to a predetermined storage position according to the selection signal, the smart device with optical dual-mode sensing module array includes: a conveyor module, a sensing module array, a selection module and a control center, the control center is coupled to the conveyor module, the sensing module array and the selection module; wherein the conveyor module transports the textile article main part from a conveyor front end of the conveyor module to a conveyor terminal end of the conveyor module; the sensing module array is provided adjacent to one side of the conveyor module and is located between the conveyor front end and the conveyor terminal end, the sensing module array includes at least one sensing module, and the at least one sensing module has one image identification module and/or one spectrum identification module, the image identification module and/or the spectrum identification module are respectively coupled to the control center; the image identification module or the control center is capable of identifying a type of a textile article main part, the spectrum identification module or the control center is capable of identifying a material of the textile article main part and generating a piece of main part material information; the selection module is provided adjacent to the conveyor terminal end of the conveyor module, the sensing module, the selection module or the control center generates the selection signal according to the type of the textile article main part and/or the main part material information, and the selection module selects the textile article main part to the predetermined storage position according to the selection signal.

According to the above-mentioned technical features, the image identification module includes at least one image capture element, the at least one image capture element is coupled to the control center; the control center includes a processing module and a storage module, the processing module is coupled to the storage module and the image capture element; the spectrum identification module includes a base, a reflective concentrator, at least one light source, at least one optical probe and at least one optical fiber, wherein the reflective concentrator is provided on the base, and the at least one light source and the at least one optical probe are provided on the reflective concentrator, the at least one optical fiber is correspondingly connected to the at least one optical probe, the at least one optical fiber is at least a part of a mutual connection between the at least one optical probe and a spectrometer, and the spectrometer is coupled to the processing module.

According to the above-mentioned technical features, the conveyor module includes a conveyor belt, the textile article main part is transported on a conveyor surface of the conveyor belt along a conveying direction of the conveyor belt; a quantity of the at least one sensing module is plural, the plurality of sensing modules are provided in a row along the conveying direction of the conveyor belt to form the sensing module array.

According to the above-mentioned technical features, in each of the spectrum identification modules, quantities of the at least one light source, the at least one optical probe and the at least one optical fiber are respectively plural, each of the optical fibers is correspondingly connected to one of the optical probes, the plurality of optical probes are intervally provided from each other and are located on an inner surface of the reflective concentrator, the plurality of light sources are intervally provided from each other on the inner surface of the reflective concentrator, none of the light sources on the inner surface of the reflective concentrator overlaps with any of the light sources, and before connecting to the spectrometer, the plurality of optical fibers are firstly integrated into an integrated optical fiber by means of an optical fiber integration module, passed through an optical fiber array switch, and then connected to the spectrometer by using a shared optical fiber.

According to the above-mentioned technical features, the optical fiber array switch includes a switch switching module and a plurality of optical fiber switches respectively coupled to the switch switching module, a path connected between each of the integrated optical fibers and the spectrometer is connected to one of the optical fiber switches correspondingly, after passing through each of the optical fiber switches, each of the integrated optical fibers is integrated into the shared optical fiber and then connected to the spectrometer, the switch switching module is coupled to the processing module, and the processing module notifies the switch switching module and controls an ON-state or OFF-state of each of the optical fiber switches, and the ON-state indicates a light may pass through, whereas the OFF-state indicates the light may not pass through.

According to the above-mentioned technical features, wherein the reflective concentrator is a hollow hemisphere having an accommodation space formed therein and also having an opening, the plurality of optical probes are intervally provided from each other and are all located on a top portion of the inner surface of the reflective concentrator.

According to the above-mentioned technical features, the reflective concentrator is a hollow hemisphere having an accommodation space formed therein and also having an opening, a part of the plurality of optical probes is provided on a top portion of the inner surface of the reflective concentrator, and a remaining part of the plurality of optical probes are intervally provided on the inner surface of the reflective concentrator and are adjacent to the opening.

According to the above-mentioned technical features, wherein the reflective concentrator is a hollow hemisphere having an accommodation space formed therein and also having an opening, the opening is completely sealed off by means of an opaque plate, and moves the plurality of light sources provided on the inner surface of the reflective concentrator to an outer surface of the opaque plate, which are intervally provided from each other on said outer surface, the opaque plate has a plurality of auxiliary optical fibers penetrated therethrough, positions of the plurality of light sources on the outer surface of the opaque plate are different from positions of the plurality of the auxiliary optical fibers.

According to the above-mentioned technical features, wherein the textile article further includes an accessory, the accessory is configured on the textile article main part, the smart device with optical dual-mode sensing module array further includes a cutting module, the cutting module is provided adjacent to the conveyor module and is provided adjacent to an array terminal end of the sensing module array, the cutting module includes an energy part and separates the accessory from the textile article main part by using the energy part.

According to the above-mentioned technical features, the selection module includes a mechanical arm, the selection module or the mechanical arm is coupled to the processing module, the selection module or the processing module notifies, according to the selection signal, a plurality of mechanical claws of the mechanical arm to pick up the textile article main part to the predetermined storage position.

According to the above-mentioned technical features, wherein the conveyor surface of the conveyor belt has a plurality of position recognition devices provided thereon, the plurality of position recognition devices are intervally provided along the conveying direction of the conveyor belt, a piece of positional information represented by each of the position recognition devices in the plurality of position recognition devices is different from that of the other position recognition devices.

According to the above-mentioned technical features, wherein the image identification module or the control center is capable of simultaneously identifying the textile article main part on the conveyor surface and the position recognition device corresponding to the textile article main part, thereby enabling the image identification module or the control center to identify the textile article main part and that the positional information thereof on the conveyor surface is a piece of textile article positional information, and the selection module selects, according to the selection signal and the textile article positional information, the textile article main part to the predetermined storage position.

On the basis of at least an object of the present invention, the present invention further provides a smart device with optical dual-mode sensing module array, used for identifying a textile article main part of a textile article, so as to generate a selection signal, and then select the textile article main part to a predetermined storage position according to the selection signal, the smart device with optical dual-mode sensing module array includes at least one sensing selection module and a control center, the at least one sensing selection module includes a sensing module and a selection module, the selection module is rotatably provided on the sensing module, and the control center is coupled to the sensing module and the selection module; wherein the sensing module has an image identification module and/or a spectrum identification module, the image identification module and/or the spectrum identification module is respectively coupled to the control center; the image identification module or the control center is capable of identifying a type of the textile article main part, the spectrum identification module or the control center is capable of identifying a material of the textile article main part and generating a piece of main part material information; the sensing module, the selection module or the control center generates the selection signal according to the type of the textile article main part and/or the main part material information, and the selection module selects the textile article main part to the predetermined storage position according to the selection signal.

According to the above-mentioned technical features, wherein the smart device with optical dual-mode sensing module array further includes a conveyor module, the control center is coupled to the conveyor module, the conveyor module transports the textile article main part from a conveyor front end of the conveyor module to a conveyor terminal end of the conveyor module; the at least one sensing selection module is provided adjacent to one side of the conveyor module and is located between the conveyor front end and the conveyor terminal end.

According to the above-mentioned technical features, wherein the selection module includes a mechanical arm and a swivel base, wherein the swivel base is rotatably provided on the base, the mechanical arm is rotatably provided on the swivel base, the image capture element is provided on a lateral portion of the mechanical arm, a top end of the mechanical arm has a plurality of mechanical claws, the mechanical arm is capable of picking up the textile article main part by means of the plurality of mechanical claws, the mechanical claws take the textile article main part to a place below the spectrum identification module or in an accommodation space inside the reflective concentrator, so as to perform identification on the textile article main part, after completing identification, the mechanical arm subsequently places the textile article main part to the predetermined storage position.

According to the above-mentioned technical features, wherein the conveyor module includes a conveyor belt, the textile article main part is transported on a conveyor surface of the conveyor belt along a conveying direction of the conveyor belt; a quantity of the at least one sensing selection module is plural, and the plurality of sensing selection modules are provided on an upper side of the conveyor belt, and are intervally provided along the conveying direction of the conveyor belt.

According to the above-mentioned technical features, wherein in each of the spectrum identification modules, quantities of the at least one light source, the at least one optical probe and the at least one optical fiber are respectively plural, each of the optical fibers is correspondingly connected to one of the optical probes, the plurality of optical probes are intervally provided from each other and are located on an inner surface of the reflective concentrator, the plurality of light sources are intervally provided from each other on the inner surface of the reflective concentrator, none of the light sources on the inner surface of the reflective concentrator overlaps with any of the light sources, and before connecting to the spectrometer, the plurality of optical fibers are firstly integrated into an integrated optical fiber by means of an optical fiber integration module, passed through an optical fiber array switch, and then connected to the spectrometer by using a shared optical fiber.

According to the above-mentioned technical features, wherein the selection module includes a mechanical arm, a swivel base and a plurality of mechanical claws, the mechanical arm is connected to the base and the swivel base is rotatably provided on the base, the plurality of mechanical claws are provided on the swivel base, the image capture element is provided on a lateral portion of the mechanical arm, the mechanical arm is capable of picking up the textile article main part by means of the plurality of mechanical claws, so as to enable the textile article main part to be located in a place below the spectrum identification module or in an accommodation space inside the reflective concentrator, so as to perform identification on the textile article main part, after completing identification, the mechanical arm subsequently places the textile article main part to the predetermined storage position.

To enable a further understanding of the said objectives and the technological methods of the invention herein, the brief description of the drawings below is followed by the detailed description of the preferred embodiments.

### BRIEF DESCRIPTION OF THE DRAWINGS

The following diagrams are provided to facilitate better understanding of the present invention by a person of ordinary skill in the art, which are combined with the description of the present invention and constitute a part thereof. The figures demonstrate the illustrative embodiments of the present invention, and are provided for explaining the principle of the present invention together with the description of the present invention.

FIG. 1 is a structural schematic view of a smart device with optical dual-mode sensing module array in accordance with the first embodiment of the present invention.

FIG. 2 is a structural schematic view of a feeding module in accordance with the first embodiment of the present invention.

FIG. 3 is a structural schematic view of a conveyor module in accordance with the first embodiment of the present invention.

FIG. 4 is a structural schematic view of a sensing module in accordance with the first embodiment of the present invention.

FIG. 5 is a structural schematic view of a spectrum identification module in accordance with the first embodiment of the present invention.

FIG. 6 is a structural schematic view of an optical fiber array switch in accordance with the first embodiment of the present invention.

FIG. 7 is a structural schematic view of a cutting module in accordance with the first embodiment of the present invention.

FIG. 8 is a structural schematic view of a selection module in accordance with the first embodiment of the present invention.

FIG. 9 is a structural schematic view (I) of a smart device with optical dual-mode sensing module array in accordance with the second embodiment of the present invention.

FIG. 10 is a structural schematic view (II) of a smart device with optical dual-mode sensing module array in accordance with the second embodiment of the present invention.

FIG. 11A is a structural schematic view (III) of a smart device with optical dual-mode sensing module array in accordance with the second embodiment of the present invention.

FIG. 11B is a structural schematic view of a spectrum identification module provided with an opaque plate in accordance with the second embodiment of the present invention.

FIG. 11C is a structural schematic view (I) of optical probes which are intervally provided adjacent to an opening of a reflective concentrator in accordance with the second embodiment of the present invention.

FIG. 11D is a structural schematic view (II) of optical probes which are intervally provided adjacent to an opening of a reflective concentrator in accordance with the second embodiment of the present invention.

FIG. 12 is a structural schematic view of a smart device with optical dual-mode sensing module array in accordance with the third embodiment of the present invention.

FIG. 13 is a structural schematic view of a smart device with optical dual-mode sensing module array in accordance with the fourth embodiment of the present invention.

### DETAILED DESCRIPTION OF THE PREFERRED EMBODIMENTS

To facilitate better understanding of the technical features, contents, advantages of the present invention and effects achieved thereby by the examiner. The present invention will be further described below in conjunction with the accompanying drawings and embodiments thereof. It should be understood that these drawings are only illustrative and supplementary to the description, and are not necessarily the true proportions and accurate configurations of implementations of the present invention, and therefore should not be restricted to the proportion and configuration relationship in the accompanying drawings, or considered as limiting the scope of protection of the present application.

### First Embodiment

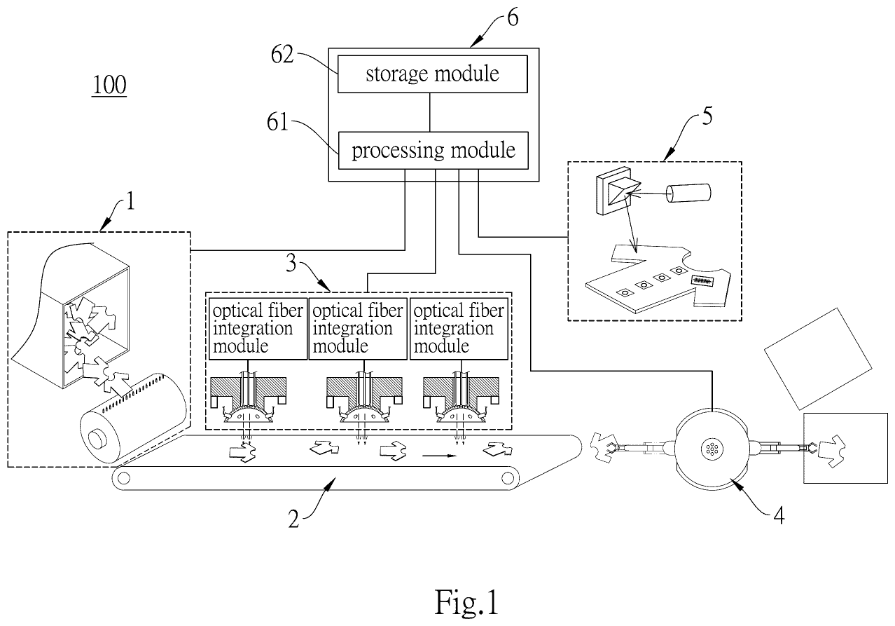

A smart device with optical dual-mode sensing module array 100 of the present invention shown in FIG. 1 comprises a feeding module 1, a conveyor module 2, a sensing module array 3, a selection module 4, a cutting module 5 and a control center 6; wherein the feeding module 1 is provided adjacent to one end of the conveyor module 2, the selection module 4 is provided adjacent to another end of the conveyor module 2, the sensing module array 3 is provided adjacent to one side of the conveyor module 2, the cutting module 5 is provided adjacent to the side of the conveyor module 2 and is provided adjacent to one end of the sensing module array 3, the control center 6 is coupled to the feeding module 1, the conveyor module 2, the sensing module array 3, the selection module 4 and/or the cutting module 5, said couplings are telecommunication connections, and can be electrical connections or signal connections. As indicated in FIG. 1, the feeding module 1 is provided adjacent to a conveyor front end of the conveyor module 2, the selection module 4 is provided adjacent to a conveyor terminal end of the conveyor module 2, the sensing module array 3 is provided adjacent to an upper side of the conveyor module 2, the cutting module 5 is provided adjacent to the upper side of the conveyor module 2 and is provided adjacent to an array terminal end of the sensing module array 3.

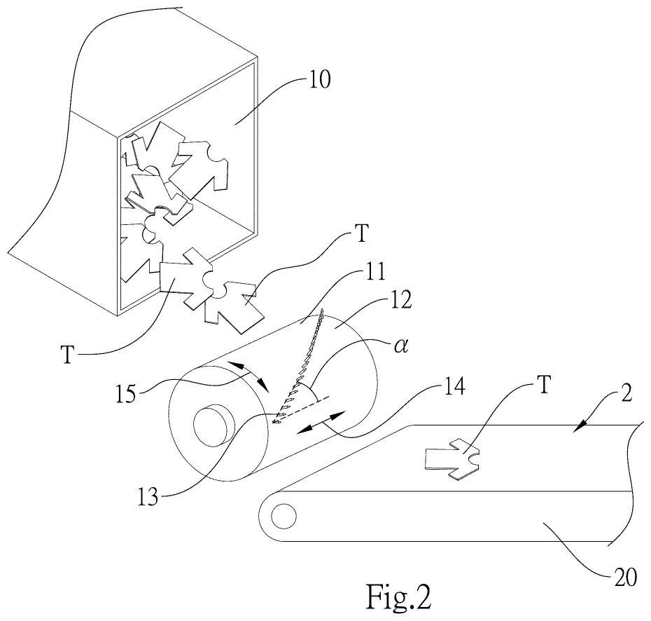

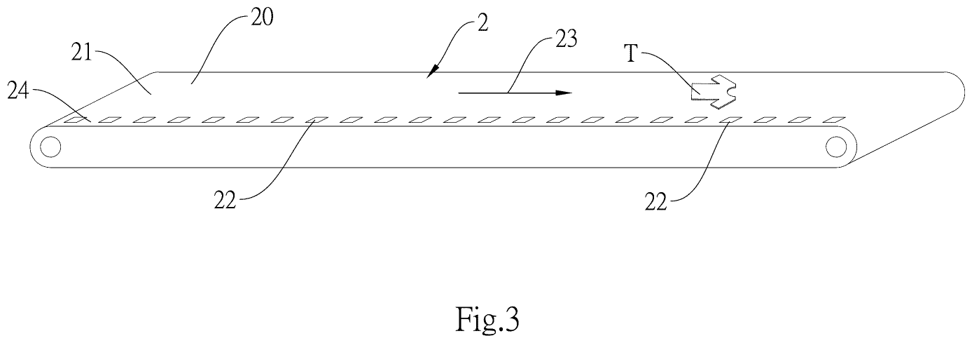

As shown in FIG. 2, the feeding module 1 (as shown in FIG. 1) sequentially places a plurality of textile articles T on the conveyor module 2. The conveyor module 2 may comprise, for instance, a conveyor belt 20, the feeding module 1 dumps a plurality of textile articles T from a container 10 onto a roller surface 12 of a roller 11, the roller surface 12 is provided with a plurality of hooks 13, and the plurality of hooks 13 are intervally provided from each other. Thus, when the roller 11 rotates towards the direction of the conveyor module 2, the plurality of hooks 13 can respectively hook onto one of the textile articles T, and then throw or drop, by means of the centrifugal force or gravity, the textile articles T onto a conveyor surface 21 of the conveyor belt 20 of the conveyor module 2 (see FIG. 3) and then be transported. Preferably, the plurality of hooks 13 are arranged along an axial direction 14 of the roller 11, so as to enable multiple positions along the axial direction 14 of the roller 11 to be respectively hooked with the textile articles T and increase the processing efficiency; preferably, the plurality of hooks 13 are arranged along the axial direction 14 and a circumferential direction 15 of the roller 11 at the same time, thus making an arrangement direction thereof form an angle α with the axial direction 14, the angle α is greater than 0 degree and less than 90 degrees, consequently not only increasing the processing efficiency, but also distancing the multiple textile articles T thrown or dropped onto the surface of the conveyor belt 20 further from each other to facilitate following processing.

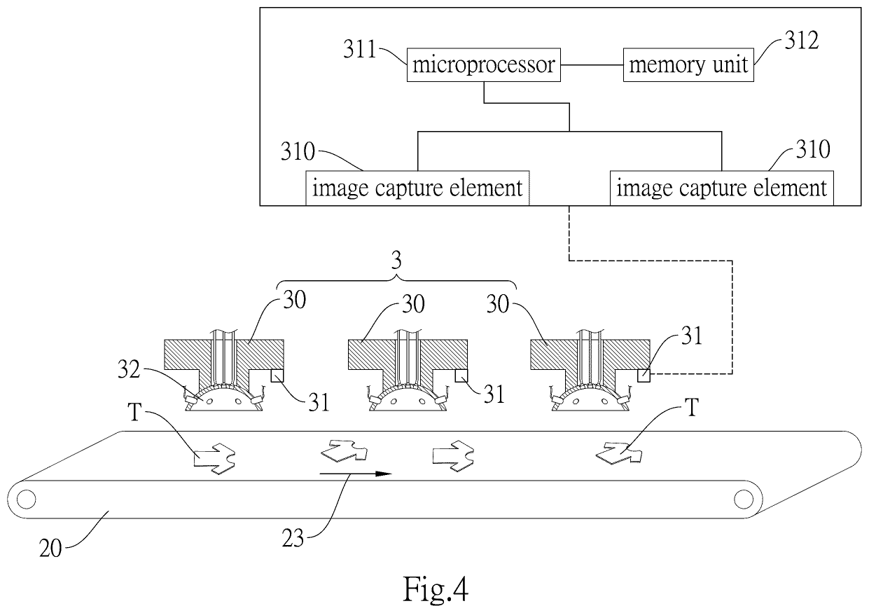

As shown in FIG. 3, the conveyor surface 21 of the conveyor belt 20 is provided with at least one position recognition device 22. Preferably, a quantity of the at least one position recognition device 22 is plural, the plurality of position recognition devices 22 are intervally provided along a conveying direction 23 of the conveyor belt 20, and more preferably, the plurality of position recognition devices 22 are provided along an edge 24 of the conveyor belt 20 to prevent coverage by the textile article T. A piece of positional information represented by each of the plurality of position recognition devices 22 is different from those of the other position recognition devices 22. In other words, in the smart device with optical dual-mode sensing module array 100 of the present invention, the positional information represented by each of the position recognition devices 22 is unique, and is different from the positional information represented by the other position recognition devices 22. The position recognition device 22 is either an active position recognition device 22 or a passive position recognition device 22, the active position recognition device 22 refers to a capability thereof to actively transmit the positional information corresponding to the position recognition device 22 to other modules or apparatus, such as the control center 6 (as shown in FIG. 1), the active position recognition device 22 can be, for instance, a transmitter which sends the positional information; the passive position recognition device 22 refers to a dependency thereof on other modules or apparatus for recognizing or specifying the positional information represented thereby, such as numbers, alphabets, markings, etc., upon identifying the numbers, the alphabets or the markings by the other modules or apparatus, such as an image identification module 31 (see FIG. 4) described later, or the control center 6, the image identification module 31 or the control center 6 provides the corresponding positional information. Furthermore, the image identification module 31 or the control center 6 is capable of simultaneously identifying or calculating the textile article T on the conveyor surface 21 and the position recognition device 22 corresponding to the textile article T, thereby enabling the image identification module 31 or the control center 6 to identify, calculate or mark the textile article T and that the positional information thereof on the conveyor surface 21 is a piece of textile article positional information.

As shown in FIG. 4, the sensing module array 3 comprises at least one sensing module 30, preferably, a quantity of the at least one sensing module 30 is plural, the plurality of sensing modules 30 are arranged in one row along the conveying direction 23 of the conveyor belt 20 to form the sensing module array 3, preferably, the plurality of sensing modules 30 are intervally provided along the conveying direction 23 of the conveyor belt 20. Each of the sensing modules 30 has an image identification module 31 and/or a spectrum identification module 32 for forming an optical dual-mode sensing module, in other words, the sensing modules 30 are the optical dual-mode sensing module, and the image identification module 31 and the spectrum identification module 32 are respectively coupled to the control center 6 (as shown in FIG. 1). The image identification module 31 comprises at least an image capture element 310, such as CCD (Charge Coupled Device) or CMOS (Complementary Metal-Oxide Semiconductor), and the image capture element 310 photographs and captures an image of the textile article T on the conveyor surface 21 (as shown in FIG. 3). Preferably, a quantity of the at least one image capture element 310 is plural. The image identification module 31 or the control center 6 is capable of identifying a type (such as towels, clothes, pants, skirts, backpacks, etc.) of a textile article main part of the textile article T, preferably, the image identification module 31 is also capable of simultaneously identifying or calculating an accessory (such as buttons, zippers, etc.) configured on the textile article main part on the conveyor surface 21 and the position recognition device 22 (as shown in FIG. 3) corresponding to the accessory, therefore, the control center 6 can identify, calculate or mark the accessory and that the positional information thereof on the conveyor surface 21 is a piece of accessory positional information.

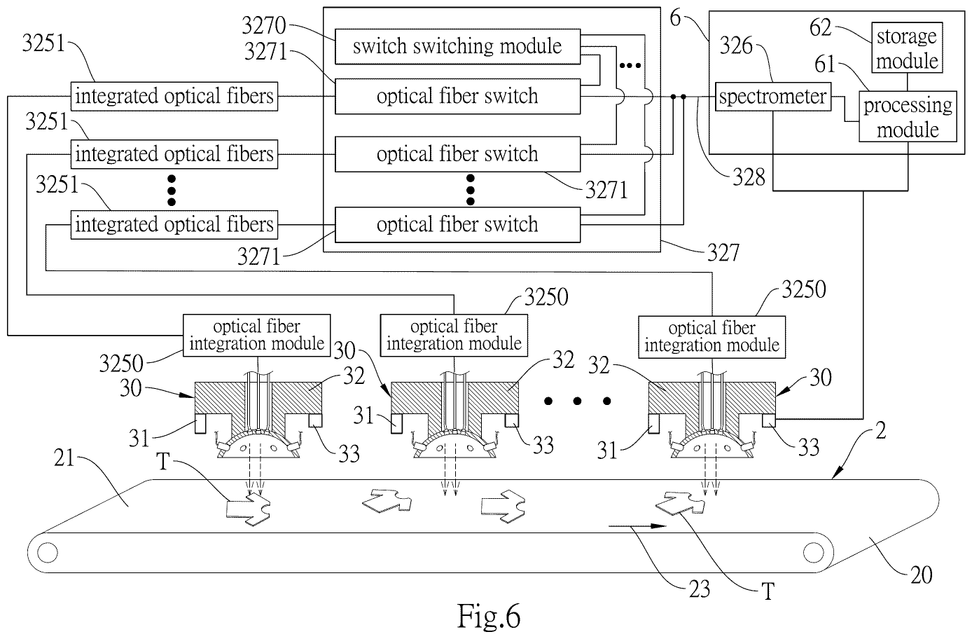

Particularly, pertinent to identification the aforementioned numbers, alphabets, markings, the textile article T, the type of the textile article main part and/or the accessory, the image identification module 31 may further comprise a microprocessor 311 and a memory unit 312, the microprocessor 311 is coupled to the memory unit 312 and the image capture element 310, the microprocessor 311 is also coupled to the control center 6 (as shown in FIG. 1), and the memory unit 312 has multiple images of predetermined numbers, predetermined alphabets or predetermined marked images and the corresponding positional information thereof pre-stored therein. The memory unit 312 is also pre-stored therein with multiple images of predetermined textile articles, types of predetermined textile article main parts and/or predetermined accessories, the microprocessor 311 compares images captured by the image capture element 310 with the aforesaid images of predetermined numbers, predetermined alphabets, predetermined markings, predetermined textile articles, types of predetermined textile article main parts and/or predetermined accessories, so as to determine the textile article T, a type of the textile article main part and/or the accessory, as well as the textile article positional information and/or the accessory positional information. In another embodiment, pertinent to identification on the aforesaid numbers, alphabets, markings, the textile article T, a type of the textile article main part and/or the accessory, an image captured by the image capture element 310 is sent to the control center 6, the control center 6 comprises a processing module 61 and a storage module 62 (see FIGS. 1 and 6), the processing module 61 is coupled to the storage module 62 and the image capture element 310, the storage module 62 is pre-stored therein with multiple images of predetermined numbers, predetermined alphabets or predetermined markings and the corresponding pieces of positional information thereof, the storage module 62 is also pre-stored therein with multiple images of predetermined textile articles, types of predetermined textile article main parts and/or predetermined accessories, the processing module 61 compares images captured by the image capture element 310 with the aforesaid images of predetermined numbers, predetermined alphabets, predetermined markings, predetermined textile articles, types of predetermined textile article main parts and/or predetermined accessories, so as to determine the textile article T, a type of the textile article main part and/or the accessory, as well as the textile article positional information and/or the accessory positional information. Particularly, a position where the textile article main part locates is the textile article positional information.

Particularly, the plurality of image capture elements 310 (as shown in FIG. 4) are intervally provided from each other, so as to enable respective photographing from different angles to capture an image of the textile article T, this is because the textile article T has a thickness and is often not completely laid out on the conveyor surface 21 (as shown in FIG. 3), therefore, photographing from different angles to capture an image of the textile article T can improve the accuracy of determining the textile article T, a type of the textile article main part and/or the accessory. In addition, during a conveying process of the textile article T on the conveyor belt 20, the image capture element 310, the image identification module 31 (as shown in FIG. 4) and/or the control center 6 is in an activated state, so as to enable, under an activated state, detection of whether the textile article T has appeared in a detection range of the image identification module 31, the spectrum identification module 32 and/or the sensing module 30 at any time, and further enable identification on the aforesaid numbers, alphabets, markings, the textile article T, a type of the textile article main part and/or the accessory. Preferably, during a conveying process of the textile article T on the conveyor belt 20, at least one of the image capture elements 310 and/or the control centers 6 in each of the image identification modules 31 is in an activated state. In addition, on the basis of the need for recording, the processing module 61 (as shown in FIG. 1) will only store an image of the textile article T captured by the image capture element 310 to the storage module 62 (as shown in FIG. 1), and will ignore images which are not of the textile article T captured by the image capture element 310 for storage to the storage module 62.

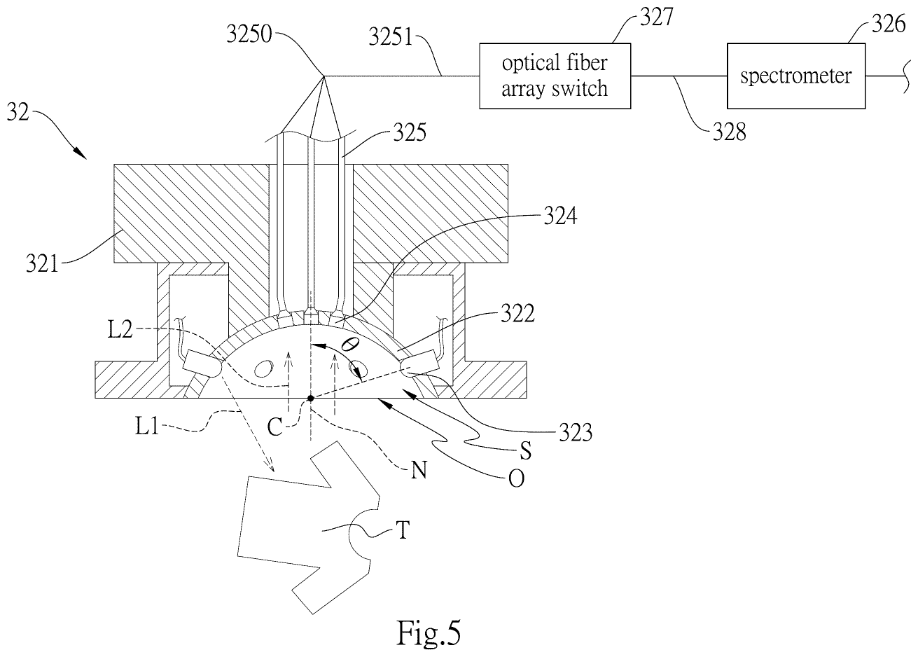

As shown in FIG. 5, the spectrum identification module 32 comprises a base 321, a reflective concentrator 322, at least one light source 323, at least one optical probe 324 and at least one optical fiber 325, wherein the reflective concentrator 322 is provided on the base 321, the at least one light source 323 and the at least one optical probe 324 are provided on the reflective concentrator 322, the at least one optical fiber 325 is correspondingly connected to the at least one optical probe 324; preferably, in each of the spectrum identification modules 32, quantities of the at least one light source 323, the at least one optical probe 324 and the at least one optical fiber 325 are plural, thus, each of the optical fibers 325 is correspondingly connected to one of the optical probe 324. Particularly, in order to save space, the image identification module 31 or the image capture element 310 may be provided on the base 321. The reflective concentrator 322 is a hollow hemisphere having an accommodation space S formed therein and also having an opening O, mainly used for concentrating light. The plurality of optical probes 324 are intervally provided from each other and are located in a central area (or referred to as a top portion) of an inner surface of the reflective concentrator 322, a distance, for instance, 2 cm, is spaced between every two of the neighboring optical probes 324. As indicated in FIG. 5, the optical probe 324 is used for collecting a reflected light L2, and the optical probe 324 is usually a convex lens for increasing collection of the reflected light L2. The plurality of light sources 323 are intervally provided from each other on an inner surface of the reflective concentrator 322, and are circularly provided around the plurality of optical probes 324, positions of the plurality of light sources 323 on the inner surface of the reflective concentrator 322 are different from positions of the plurality of optical probes 324, in other words, none of the light sources 323 on the inner surface of the reflective concentrator 322 overlaps with any of the light sources 323. The light source 323 is mainly used for providing an incident light L1 to illuminate onto the textile article T so as to generate the reflected light L2, and then the reflected light L2 is concentrated to the optical probe 324 by means of the reflective concentrator 322, each of the optical fibers 325 is used for transmitting the reflected light L2 collected by the optical probe 324 correspondingly connected thereto to a spectrometer 326 to generate a spectral signal, the spectrometer 326 is coupled to the processing module 61 and can transmit the spectral signal to the processing module 61, so as to enable use by a laser distance sensor module 33 (see FIG. 6) provided and described later. The spectrometer 326 is, for instance, ATR-FTIR (Attenuated Total Reflectance Fourier-Transform Infrared Spectroscopy), therefore, the spectrometer 326 or the processing module 61 can identify a material of the textile article main part and/or a material of the accessory by using the spectral signal, and then respectively generate a piece of main part material information and/or a piece of accessory material information, the spectrometer 326 further sends the main part material information and/or the accessory material information to the processing module 61, and the processing module 61 stores the main part material information and/or the accessory material information to the storage module 62. Particularly and preferably, a quantity of the plurality of light sources 323 is two and a quantity of the plurality of optical fibers 325 is five, and before being connected to the spectrometer 326, the five optical fibers 325 are firstly integrated into an integrated optical fiber 3251 by means of an optical fiber integration module 3250, and then passed through an optical fiber array switch 327 (see FIG. 6), and connected to the spectrometer 326 by means of a shared optical fiber 328, wherein a connecting line from the optical probe 324 to a virtual center of a sphere C of the hemispherical reflective concentrator 322 is a normal line N, the incident light L1 emitted by the light source 323 illuminates, in a manner which forms an angle θ of 45 degrees with the normal line N, onto the textile article T below the reflective concentrator 322, which also enables the reflected light L2 generated by the textile article T to be more concentrated on the optical probe 324 located on the normal line N, so as to improve the accuracy of measurement. Preferably, the light source 323 is provided on an inner surface of the reflective concentrator 322, which forms an angle θ of 45 degrees with the normal line N. Particularly, when quantities of the at least one optical probe 324 and the at least one optical fiber 325 are respectively one, the optical fiber 325 may be directly connected to the optical fiber array switch 327, without requiring the optical fiber integration module 3250 and the integrated optical fiber 3251.

As shown in FIG. 6, the aforesaid plurality of sensing modules 30 are arranged in one row along the conveying direction 23 of the conveyor belt 20, therefore, the plurality of spectrum identification modules 32 are also arranged in one row along the conveying direction 23 of the conveyor belt 20. The spectrum identification module 32 may further comprise the optical fiber array switch 327, the optical fiber array switch 327 comprises a switch switching module 3270 and a plurality of optical fiber switches 3271 which are respectively coupled to the switch switching module 3270, a path connected between each of the integrated optical fibers 3251 and the spectrometer 326 is connected to one of the optical fiber switches 3271 correspondingly, after passing through each of the optical fiber switches 3271, each of the integrated optical fibers 3251 is integrated into the shared optical fiber 328 and then connected to the spectrometer 326, the switch switching module 3270 is coupled to the processing module 61, and the processing module 61 notifies the switch switching module 3270 and controls an ON/OFF (ON or OFF) state of each of the optical fiber switches 3271, and the ON-state of the optical fiber switches 3271 indicates a light (the reflected light L2) may pass through, whereas the OFF-state thereof indicates the light (the reflected light L2) may not pass through. When the microprocessor 311 (as shown in FIG. 4) or the processing module 61 detects the textile article T, which is when the textile article T appears in the detection range of one of the image identification module 31, the spectrum identification module 32 and/or the sensing module 30, the processing module 61 notifies the switch switching module 3270 to control the corresponding optical fiber switch 3271 to be in an ON-state, and control the other optical fiber switches 3271 to be in an OFF-state, thereby improving the accuracy of identification on a material of the textile article main part and/or a material of the accessory by the spectrometer 326, such that the main part material information and/or the accessory material information is more precise. For example, as shown in FIG. 6, the plurality of sensing modules 30 are arranged in one row along the conveying direction 23 of the conveyor belt 20, the optical fiber switch 3271 corresponding to the front-most sensing module 30 (which is the first sensing module) and the spectrum identification module 32 thereof (which is the first spectrum identification module) is the first optical fiber switch, when the image identification module 31 (which is the first image identification module) or the processing module 61 identifies that the textile article T has appeared in the detection range of the first image identification module, the first spectrum identification module and/or the first sensing module, the processing module 61 notifies the switch switching module 3270 and controls the corresponding first optical fiber switch to be in an ON-state, and controls the second optical fiber switch to the nth optical fiber switches to be in an OFF-state. In addition, the textile article T is transported towards the second spectrum identification module along the conveying direction 23 of the conveyor belt 20, the second image identification module or the processing module 61 identifies that the textile article T has appeared in the detection range of the second image identification module, the second spectrum identification module and/or the second sensing module, the processing module 61 notifies the switch switching module 3270 and controls the corresponding second optical fiber switch to be in an ON-state, and controls the first optical fiber switch, the third optical fiber switch to the nth optical fiber switches to be in an OFF-state. Therefore, after the textile article T has passed through the first sensing module to the nth sensing module, n number of identifications on a material of the textile article main part and/or a material of the accessory has been accumulated, such that the main part material information and/or the accessory material information is made more precise, for example, the accumulated n number of the main part material information and/or the accessory information are summed up and then the mean is calculated therefrom. The use of the optical fiber array switch 327 enables the smart device with optical dual-mode sensing module array 100 of the present invention to only require one of the spectrometers 326, without needing to provide the spectrometer 326 in a quantity corresponding to the quantity of the plurality of spectrum identification modules 32, thereby significantly reducing the setup cost.

As shown in FIG. 6, the sensing module 30 further comprises a distance sensor module 33, the distance sensor module 33 employs light distance measurement (such as laser distance measurement) or sound wave distance measurement (such as ultrasonic distance measurement), the laser distance sensor module 33 may be provided on the base 321 (as shown in FIG. 5) or the reflective concentrator 322 (as shown in FIG. 5) and is coupled to the processing module 61 or the spectrometer 326, and the storage module 62 further comprises a plurality of distance factors, each of the distance factors corresponds to a preset distance value. When the microprocessor 311 (as shown in FIG. 4) or the processing module 61 determines that the textile article T has appeared in the detection range of one of the image identification module 31, the spectrum identification module 32 and/or the sensing module 30, the processing module 61 activates the laser distance sensor module 33, which measures a measurement distance between the laser distance sensor module 33 or the spectrum identification module 32 and the textile article T, the textile article main part and/or the accessory at the same time, and generates a measurement distance signal according to the measured measurement distance, and then sends the measurement distance signal to the processing module 61 or the spectrometer 326, the processing module 61 or the spectrometer 326 then performs correction on the spectral signal on the basis of the measurement distance signal. Since each of the textile articles T has a thickness which is different from each other, and is often not completely laid out on the conveyor surface 21, the aforesaid correction is obtained by firstly getting the measurement distance by using the laser distance sensor module 33 for measurement, and then the processing module 61 or the spectrometer 326 compares the measurement distance with the preset distance values to look for an identical value or a value within a preset error range, so as to get the corresponding distance factor, and then multiply the spectral signal withe distance factor to respectively calculate a corrected spectral signal. Particularly, if the sensing module 30 comprises the laser distance sensor module 33 and has activated the laser distance sensor module 33, the spectrometer 326 or the processing module 61 can identify a material of the textile article main part and/or a material of the accessory by using the corrected spectral signal, and then respectively generate the main part material information and/or the accessory material information, the spectrometer 326 further sends the main part material information and/or the accessory material information to the processing module 61. Therefore, the distance sensor module 33 can improve the accuracy of identification by the spectrometer 326 or the processing module 61 on the material of the textile article main part and/or the material of the accessory, such that the main part material information and/or the accessory material information is made more precise.

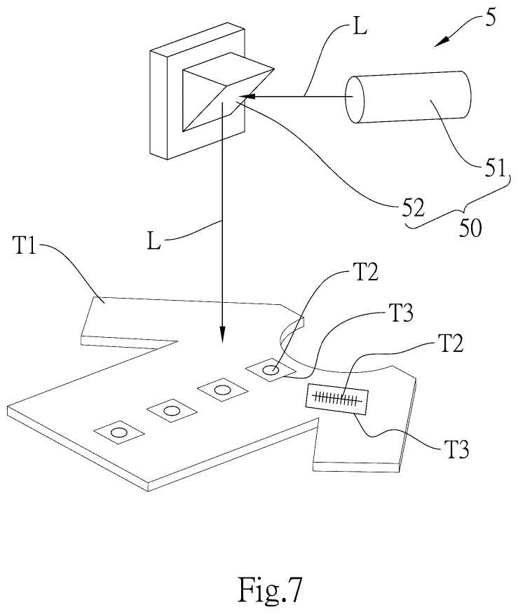

As shown in FIG. 7, the cutting module 5 cuts the accessory T2 on the textile article T (as shown in FIG. 2) away from the textile article main part T1, for instance, an energy part 50 is used for separating the accessory T2 away from the textile article main part T1, and the energy part 50 may be a device which uses laser or high frequency. The energy part 50 is coupled to the processing module 61 (as shown in FIG. 1), the processing module 61 or the energy part 50 designates, on the basis of the aforesaid textile article positional information and/or the accessory positional information, a cutting range T3 by using the accessory positional information, for instance, the cutting range T3 may be circular, and then activates the energy part 50 to separate the accessory T2 from the textile article main part T1 along the cutting range T3 by means of an energy, or the energy part 50 directly destroys the accessory T2 by means of the energy. For example, the energy part 50 comprises a laser generator 51 and a rotating reflector 52, the laser generator 51 generates a laser light L (the energy) and illuminates the laser light L on the textile article main part T1 along the cutting range T3 via rotation of the rotating reflector 52, so as to separate the accessory T2 from the textile article main part T1 along the cutting range T3, or the laser light L directly destroys the accessory T2 to enable the same to be easily separated from the textile article main part T1. Particularly, since the textile article T is still on the conveyor surface 21 (as shown in FIG. 3) at the moment, to prevent the energy (laser light) from destroying the conveyor belt 20 (as shown in FIG. 3), a material of the conveyor belt 20 is preferably metal, for instance, a metal belt, or other materials that are resistant to laser cutting, or an amount and a focal length of the energy (laser light) is calculated to prevent the same from destroying the conveyor belt 20. Particularly, if the accessory T2 is absent in the textile article T, the smart device with optical dual-mode sensing module array 100 may not be configured with the energy part 50, or the smart device with optical dual-mode sensing module array 100 may be configured with the energy part 50 but can stop activating the same selectively.

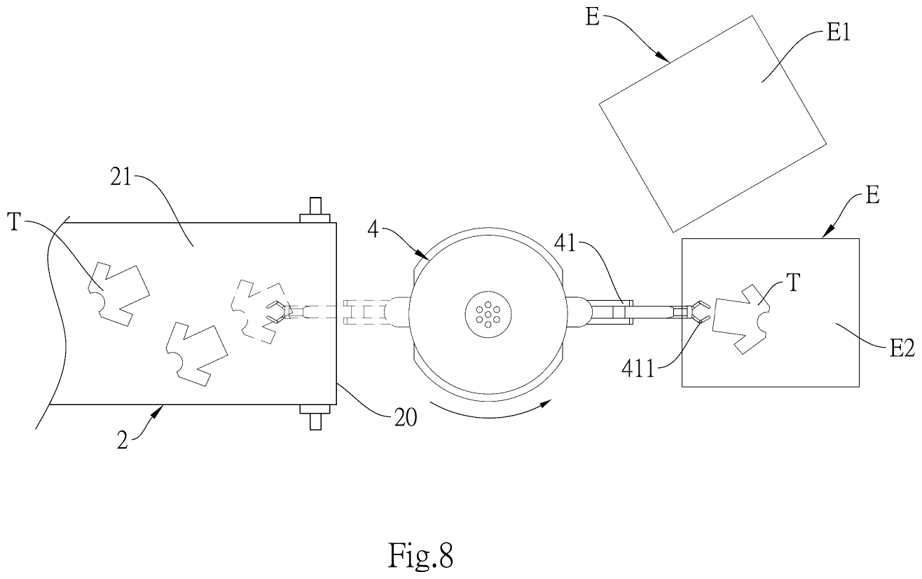

As shown in FIG. 8, the selection module 4 comprises a mechanical arm 41, the selection module 4 or the mechanical arm 41 is coupled to the processing module 61 (as shown in FIG. 1), the sensing module 30 (as shown in FIG. 4), the selection module 4 or the processing module 61 generates, according to the type of the textile article main part, the main part material information and/or the textile article positional information, a selection signal, and the selection module 4 selects the textile article main part T1 (as shown in FIG. 7) to a predetermined storage position E according to the selection signal. For example, the selection module 4 or the processing module 61 notifies, according to the selection signal, a plurality of mechanical claws 411 of the mechanical arm 41 to pick up the textile article main part T1 to a storage basket E1 located in the predetermined storage position E according to the textile article positional information, whereas the accessory T2 (as shown in FIG. 7) is dropped on a path for collection and will not be put into the storage basket E1.

In another embodiment, the cutting module 5 (as shown in FIG. 1) is not provided adjacent to the upper side of the conveyor module 2 (as shown in FIG. 1) as described before, but is provided adjacent to the array terminal end of the sensing module array 3 (as shown in FIG. 1), and the predetermined storage position E is provided with a platform E2, the cutting module 5 is provided above the platform E2, the selection module 4 or the processing module 61 (as shown in FIG. 1) notifies, according to the textile article positional information, the plurality of mechanical claws 411 of the mechanical arm 41 to pick up the textile article main part T1 to the platform E2 located in the predetermined storage position E, and the cutting module 5 separates the accessory T2 (as shown in FIG. 7) from the textile article main part T1 (as shown in FIG. 7) as described before.

### Second Embodiment

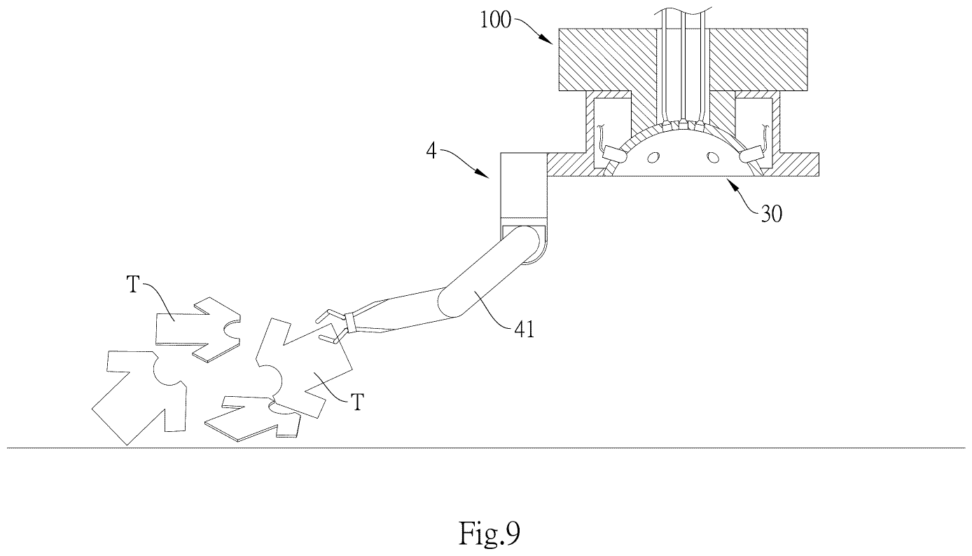

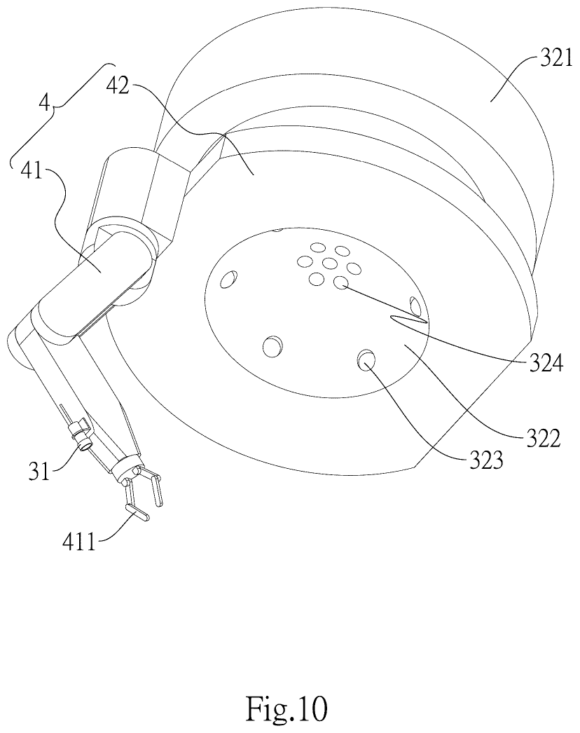

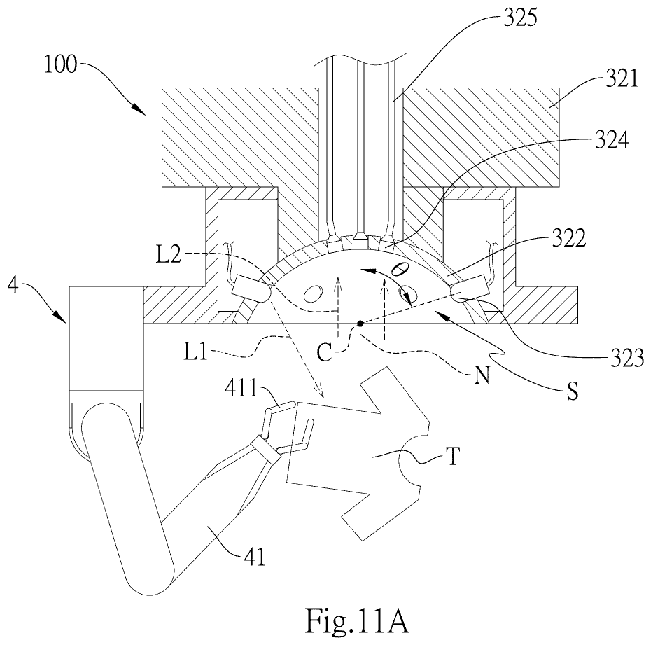

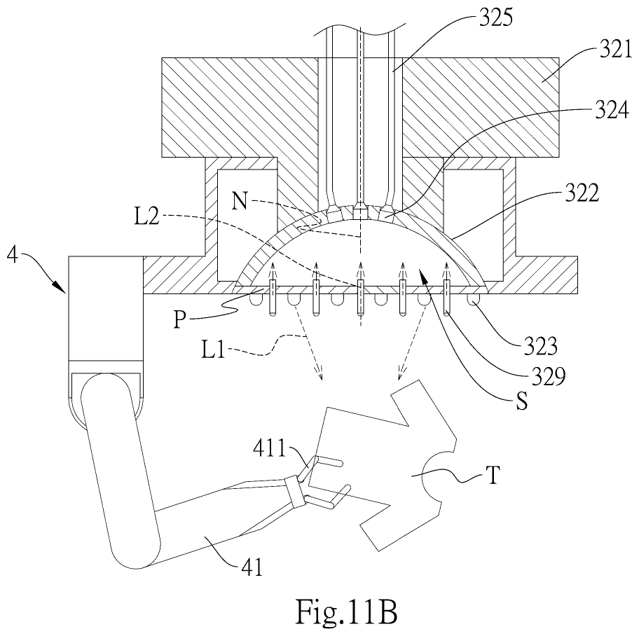

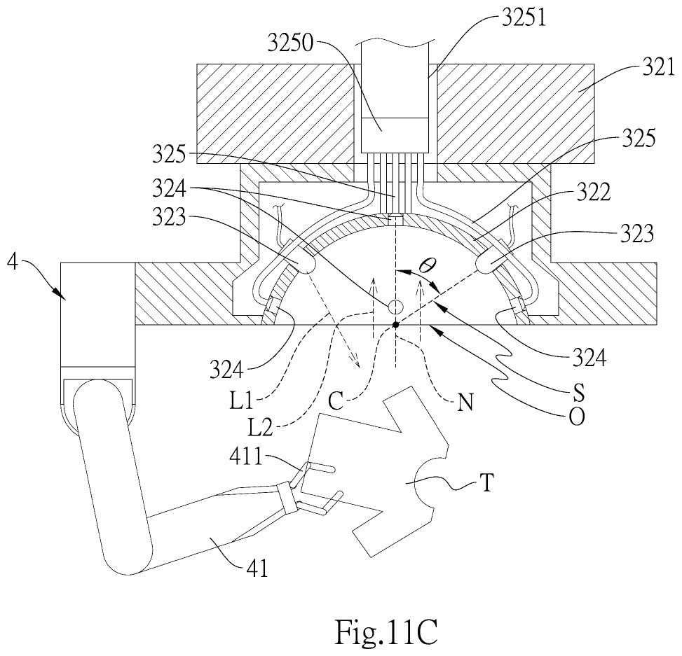

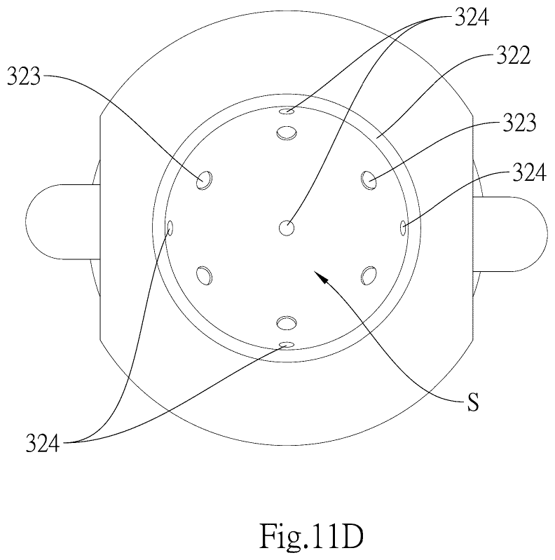

As shown in the second embodiment in FIGS. 9, 10, 11A, 11B and 11C, wherein the components and numbers which are identical to those in the first embodiment and connection relationships thereof will not be repeated here, and the difference from the above-mentioned description lies in that the sensing module 30 and the selection module 4 are integrated into a sensing selection module, the selection module 4 comprises the mechanical arm 41 and a swivel base 42, the swivel base 42 is rotatably provided on the base 321, the mechanical arm 41 is rotatably provided on the swivel base 42, and is located on one end of the base 321 which is close to the reflective concentrator 322. The image capture element 310 (as shown in FIG. 4) is provided on a lateral portion of the mechanical arm 41. A top end of the mechanical arm 41 has the plurality of mechanical claws 411, so as to enable the mechanical arm 41 to pick up the textile article T by means of the plurality of mechanical claws 411. Operations of the mechanical arm 41, the swivel base 42 and the plurality of mechanical claws 411 of the selection module 4 can also be controlled by the processing module 61 (as shown in FIG. 1), for instance, the processing module 61 controls a rotation angle of the swivel base 42, an active position of the mechanical arm 41 and/or a pick-up action of the textile article T by the plurality of mechanical claws 411. The mechanical claws 411 of the mechanical arm 41 picks up the textile article T to a place below the spectrum identification module 32 (as shown in FIG. 4) or in the accommodation space S inside the reflective concentrator 322, so as to perform identification on the textile article T, after completing identification, the mechanical arm 41 then places the textile article T to the aforesaid predetermined storage position E (as shown in FIG. 8), as a result, the speed of identifying and processing the textile article T at a large number can be accelerated. In FIG. 11A, the mechanical claw 411 of the mechanical arm 41 picks up the textile article T to a place below the spectrum identification module 32 (as shown in FIG. 4). As shown in FIG. 11B, the opening O (as shown in FIG. 5) is sealed off by means of an opaque plate P, and moves the plurality of light sources 323 provided on the inner surface of the reflective concentrator 322 to an outer surface of the opaque plate P, which are intervally provided from each other on said outer surface, in other words, the plurality of light sources 323 are intervally provided from each other on the outer surface of the opaque plate P instead of being provided on the inner surface of the reflective concentrator 322, the opaque plate P has a plurality of auxiliary optical fibers 329 penetrated therethrough, so as to enable the reflected light L2 to enter into the accommodation space S via the plurality of auxiliary optical fibers 329, and positions of the plurality of light sources 323 on the outer surface of the opaque plate P are different from positions of the plurality of the auxiliary optical fibers 329. Accordingly, the provision of the opaque plate P prevents the reflective concentrator 322 from being affected by the incident light L1 of the plurality of light sources 323, thus, the accuracy of identification by the spectrometer 326 on the material of the textile article main part and/or the material of the accessory can be improved, such that the main part material information and/or the accessory material information is made more precise. Particularly, the mode of embodiment for the spectrum identification module 32 (as shown in FIG. 4) illustrated in FIG. 11B is also applicable to the aforesaid Embodiment 1, and the mode of embodiment thereof will not be repeated here. Particularly, the smart device with optical dual-mode sensing module array 100 of the present invention may also comprise only the sensing selection module.

FIGS. 11A and 11B are applicable to scenarios in which the textile article T is located below the spectrum identification module 32 (as shown in FIG. 4), whereas FIG. 11C is applicable to scenarios in which the textile article T is located in the accommodation space S inside the reflective concentrator 322. In FIG. 11C, a part of the plurality of optical probes 324 is provided on a top portion of the inner surface of the reflective concentrator 322, and a remaining part of the plurality of optical probes 324 are intervally provided on the inner surface of the reflective concentrator 322 and are adjacent to the opening O, and each of the optical fibers 325 is correspondingly connected to one of the optical probes 324; for example, in FIGS. 11C and 11D, one of the five optical probes 324 is provided on the top portion of the inner surface of the reflective concentrator 322, whereas the remaining four of the optical probes 324 are evenly provided on the inner surface of the reflective concentrator 322 and are adjacent to the opening O.

### Third Embodiment

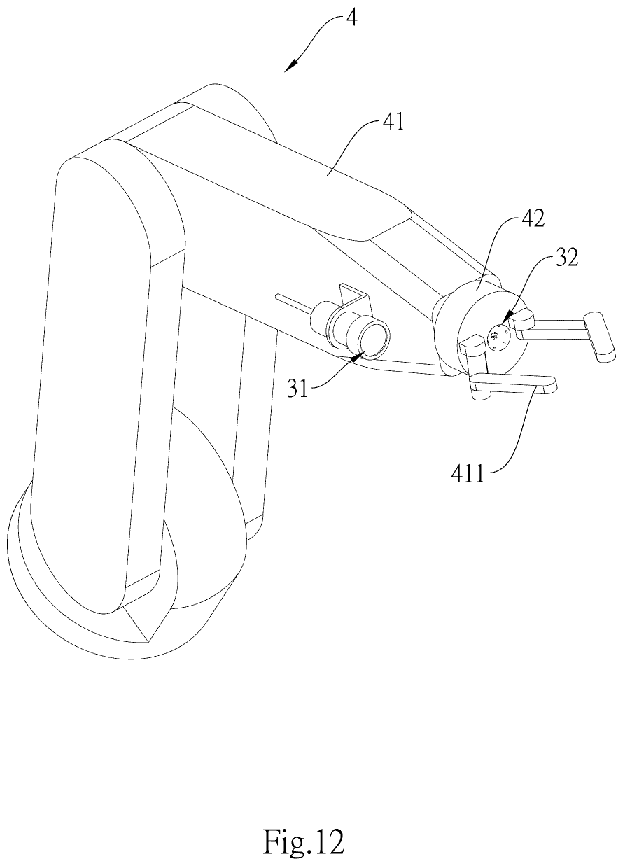

As shown in the third embodiment of FIG. 12, wherein the components and numbers which are identical to those in the first and the second embodiments and connection relationships thereof will not be repeated here. The sensing module 30 (as shown in FIG. 4) is provided on the selection module 4, for instance, the spectrum identification module 32 is mounted on a top end of the mechanical arm 41, the mechanical arm 41 is connected to the base 321 (as shown in FIG. 5) and the mechanical claw 411 is provided on the swivel base 42, and the image identification module 31 is provided on a lateral portion of the mechanical arm 41. Operations of the third embodiment of the present invention are described hereafter, when the mechanical arm 41 is close to the textile article T (as shown in FIG. 2), or when the mechanical claw 411 of the mechanical arm 41 has already picked up the textile article T, the mechanical claw 411 of the mechanical arm 41 is not required to, as in the second embodiment, take the textile article T to a place below the spectrum identification module 32, but can directly use the spectrum identification module 32 mounted on the top end of the mechanical arm 41 to perform identification on the textile article T, after completing identification, the mechanical arm 41 then places the textile article T to the aforesaid predetermined storage position E (as shown in FIG. 8), as a result, the speed of identifying and processing the textile article T at a large number can be accelerated. Particularly, the third embodiment may also have the spectrum identification module 32 provided on one of the plurality of mechanical claws 411, such that when the plurality of mechanical claws 411 pick up the textile article T, the spectrum identification module 32 on the mechanical claw 411 can directly sense the textile article T.

### Fourth Embodiment

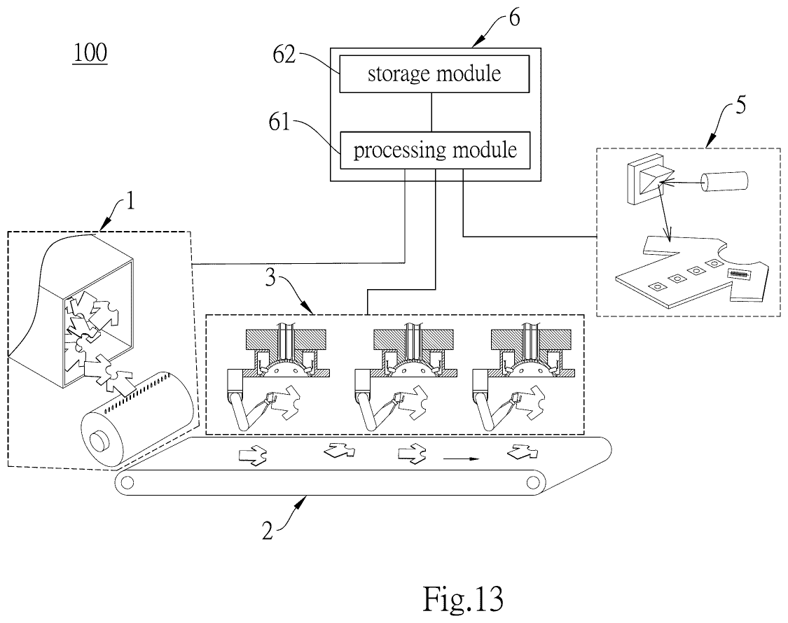

As shown in the fourth embodiment of FIG. 13, wherein the components and numbers which are identical to those in the previous embodiments and connection relationships thereof will not be repeated here. The smart device with optical dual-mode sensing module array 100 comprises the feeding module 1, the conveyor module 2, at least one of the sensing selection module, the cutting module 5 and the control center 6, preferably, a quantity of the at least one sensing selection module is plural, the plurality of sensing selection modules are provided adjacent to an upper side of the conveyor module 2 and are intervally provided along the conveying direction 23 (as shown in FIG. 3) of the conveyor belt 20 (as shown in FIG. 2), such that if the conveyor module 2 is conveying too fast, the plurality of sensing selection modules can work individually and perform sensing and selection in time. The difference between the fourth embodiment and the first embodiment of FIG. 1 lies in that the sensing module 30 and the selection module 4 (as shown in FIG. 1) are integrated into the sensing selection module, the selection module 4 or the processing module 61 notifies, according to the textile article positional information, the plurality of mechanical claws 411 (as shown in FIG. 8) of the mechanical arm 41 (as shown in FIG. 8) to take the textile article main part T1 (as shown in FIG. 7) to a place below the spectrum identification module 32 (as shown in FIG. 4) or in the accommodation space S (as shown in FIG. 5) inside the reflective concentrator 322 (as shown in FIG. 5), so as to perform identification on the textile article main part T1, the cutting module 5 is not provided, as shown in FIG. 1, adjacent to the upper side of the conveyor module 2 nor is the same provided adjacent to the array terminal end of the sensing module array 3, but the predetermined storage position E (as shown in FIG. 8) is provided with the platform E2 (as shown in FIG. 8) and the cutting module 5 is provided above the platform E2, the selection module 4 or the processing module 61 notifies, according to the selection signal, the plurality of mechanical claws 411 of the mechanical arm 41 to select the textile article main part T1 to the platform E2 located in the predetermined storage position E, and the cutting module 5 separates the accessory T2 (as shown in FIG. 7) from the textile article main part T1 as described before.

Particularly, since the textile article main part T1 takes up the majority or even all of the textile article T, it can be understood that the textile article main part T1 and the textile article T are mutually replaceable according to requirements in the description of all of the aforesaid embodiments.

In summary, the smart device with optical dual-mode sensing module array of the present invention has an image identification module and a spectrum identification module, so as to form an optical dual-mode sensing module, the same is capable of identifying a type and accessories of a textile article main part of a textile article, as well as a material of a main part and/or materials of the accessories, thereby improving accuracy of identification. The smart device with optical dual-mode sensing module array further comprises a conveyor module, a selection module and/or a cutting module, so as to enable correct selections and correct recovery, and processing of clothes rapidly at a large number.

It should be understood that the above-mentioned embodiments are merely for illustrating the technical ideas and characteristics of the present invention, the purpose thereof is to allow a person of ordinary skill in the art to understand the content of the present invention and make implementations accordingly, and are not to be used to limit the scope of the present invention. Any simple changes and modifications which are effectually equivalent and made according to the spirit disclosed in the present invention still fall within the scope of the claims of the present invention.

What is claimed is:

1. A smart device with optical dual-mode sensing module array, used for identifying a textile article main part of a textile article, thereby generating a selection signal, and then select the textile article main part to a predetermined storage position according to the selection signal, the smart device with optical dual-mode sensing module array comprising: a conveyor module; a sensing module array; a selection module and a control center; the control center being coupled to the conveyor module, the sensing module array and the selection module; wherein
the conveyor module transports the textile article main part from a conveyor front end of the conveyor module to a conveyor terminal end of the conveyor module; the sensing module array is provided adjacent to one side of the conveyor module and is located between the conveyor front end and the conveyor terminal end, the sensing module array comprises at least one sensing module, the at least one sensing module has an image identification module and/or a spectrum identification module, the image identification module and/or the spectrum identification module is respectively coupled to the control center; the image identification module or the control center is capable of identifying a type of the textile article main part, the spectrum identification module or the control center is capable of identifying a material of the textile article main part and generating a piece of main part material information; the selection module is provided adjacent to the conveyor terminal end of the conveyor module; the at least one sensing module, the selection module or the control center generate the selection signal according to the type of the textile article main part and/or the main part material information; and the selection module selects the textile article main part to the predetermined storage position according to the selection signal.

2. The smart device with optical dual-mode sensing module array of claim 1, wherein: the image identification module comprises at least an image capture element, the at least one image capture element is coupled to the control center; the control center comprises a processing module and a storage module, the processing module is coupled to the storage module and the image capture element; the spectrum identification module comprises a base, a reflective concentrator, at least one light source, at least one optical probe and at least one optical fiber, wherein the reflective concentrator is provided on the base, and the at least one light source and the at least one optical probe are provided on the reflective concentrator, the at least one optical fiber is correspondingly connected to the at least one optical probe, the at least one optical fiber is at least a part of a mutual connection between the at least one optical probe and a spectrometer, and the spectrometer is coupled to the processing module.

3. The smart device with optical dual-mode sensing module array of claim 2, wherein the conveyor module comprises a conveyor belt, the textile article main part is transported on a conveyor surface of the conveyor belt along a conveying direction of the conveyor belt; a quantity of the at least one sensing module is plural, and the plurality of sensing modules is provided in a row along the conveying direction of the conveyor belt to form the sensing module array.

4. The smart device with optical dual-mode sensing module array of claim 3, wherein in each of the spectrum identification modules, quantities of the at least one light source, the at least one optical probe and the at least one optical fiber are respectively plural, each of the optical fibers is correspondingly connected to one of the optical probes, the plurality of optical probes are intervally provided from each other and are located on an inner surface of the reflective concentrator, the plurality of light sources are intervally provided from each other on the inner surface of the reflective concentrator, none of the light sources on the inner surface of the reflective concentrator overlaps with any of the light sources, and before being connected to the spectrometer, the plurality of optical fibers are firstly integrated into an integrated optical fiber by means of an optical fiber integration module, passed through an optical fiber array switch, and then connected to the spectrometer by using a shared optical fiber.

5. The smart device with optical dual-mode sensing module array of claim 4, wherein the optical fiber array switch comprises a switch switching module and a plurality of optical fiber switches respectively coupled to the switch switching module, a path connected between each of the integrated optical fibers and the spectrometer is connected to one of the optical fiber switches correspondingly, after passing through each of the optical fiber switches, each of the integrated optical fibers is integrated into the shared optical fiber and then connected to the spectrometer, the switch switching module is coupled to the processing module, and the processing module notifies the switch switching module and controls an ON-state or OFF-state of each of the optical fiber switches, and the ON-state indicates a light may pass through, and the OFF-state indicates the light may not pass through.

6. The smart device with optical dual-mode sensing module array of claim 5, wherein the reflective concentrator is a hollow hemisphere having an accommodation space formed therein and also having an opening, the plurality of optical probes are intervally provided from each other and are all located on a top portion of the inner surface of the reflective concentrator.

7. The smart device with optical dual-mode sensing module array of claim 5, wherein the reflective concentrator is a hollow hemisphere having an accommodation space formed therein and also having an opening, a part of the plurality of optical probes is provided on a top portion of the inner surface of the reflective concentrator, and a remaining part of the plurality of optical probes are intervally provided on the inner surface of the reflective concentrator and are adjacent to the opening.

8. The smart device with optical dual-mode sensing module array of claim 5, wherein the reflective concentrator is a hollow hemisphere having an accommodation space formed therein and also having an opening, the opening is completely sealed off by means of an opaque plate, and moves the plurality of light sources provided on the inner surface of the reflective concentrator to an outer surface of the opaque plate, which are intervally provided from each other on the outer surface, the opaque plate has a plurality of auxiliary optical fibers penetrated therethrough, positions of the plurality of light sources on the outer surface of the opaque plate are different from positions of the plurality of the auxiliary optical fibers.

9. The smart device with optical dual-mode sensing module array of claim 5, wherein the textile article further comprises an accessory, the accessory is configured on the textile article main part, the smart device with optical dual-mode sensing module array further comprises a cutting module, the cutting module is provided adjacent to the conveyor module and is provided adjacent to an array terminal end of the sensing module array, the cutting module comprises an energy part and separates the accessory from the textile article main part by using the energy part.

10. The smart device with optical dual-mode sensing module array of claim 9, wherein the selection module comprises a mechanical arm, the selection module or the mechanical arm is coupled to the processing module, the selection module or the processing module notifies, according to the selection signal, a plurality of mechanical claws of the mechanical arm to pick up the textile article main part to the predetermined storage position.

11. The smart device with optical dual-mode sensing module array of claim 3, wherein the conveyor surface of the conveyor belt has a plurality of position recognition devices provided thereon, the plurality of position recognition devices are intervally provided along the conveying direction of the conveyor belt, a piece of positional information represented by each of the position recognition devices in the plurality of position recognition devices is different from that of the other position recognition devices.

12. The smart device with optical dual-mode sensing module array of claim 11, wherein the image identification module or the control center is capable of simultaneously identifying the textile article main part on the conveyor surface and the position recognition device corresponding to the textile article main part, thereby enabling the image identification module or the control center to identify the textile article main part and that the positional information thereof on the conveyor surface is a piece of textile article positional information, and the selection module selects, according to the selection signal and the textile article positional information, the textile article main part to the predetermined storage position.

13. A smart device with optical dual-mode sensing module array, used for identifying a textile article main part of a textile article, thereby generating a selection signal, and then selecting the textile article main part to a predetermined storage position according to the selection signal, the smart device with optical dual-mode sensing module array comprising: at least one sensing selection module and a control center, the at least one sensing selection module comprising a sensing module and a selection module, the selection module being rotatably provided on the sensing module, the control center being coupled to the sensing module and the selection module; wherein:
the sensing module has an image identification module and/or a spectrum identification module, the image identification module and/or the spectrum identification module are respectively coupled to the control center; the image identification module or the control center being capable of identifying a type of the textile article main part, the spectrum identification module or the control center being capable of identifying a material of the textile article main part and generating a piece of main part material information; the sensing module, the selection module or the control center generating the selection signal according to the type of the textile article main part and/or the main part material information; and the selection module selecting the textile article main part to the predetermined storage position according to the selection signal.

14. The smart device with optical dual-mode sensing module array of claim 13, wherein the smart device with optical dual-mode sensing module array further comprises a conveyor module, the control center is coupled to the conveyor module, the conveyor module transports the textile article main part from a conveyor front end of the conveyor module to a conveyor terminal end of the conveyor module; the at least one sensing selection module is provided adjacent to one side of the conveyor module and is located between the conveyor front end and the conveyor terminal end.

15. The smart device with optical dual-mode sensing module array of claim 14, wherein: the image identification module comprises at least an image capture element, the control center comprises a processing module and a storage module, the processing module is coupled to the storage module and the image capture element; the spectrum identification module comprises a base, a reflective concentrator, at least one light source, at least one optical probe and at least one optical fiber, wherein the reflective concentrator is provided on the base, and the at least one light source and the at least one optical probe are provided on the reflective concentrator, the at least one optical fiber is correspondingly connected to the at least one optical probe, the at least one optical fiber is at least a part of a mutual connection between the at least one optical probe and a spectrometer, and the spectrometer is coupled to the processing module.

16. The smart device with optical dual-mode sensing module array of claim 15, wherein the selection module comprises a mechanical arm and a swivel base, the swivel base is rotatably provided on the base, the mechanical arm is rotatably provided on the swivel base, the image capture element is provided on a lateral portion of the mechanical arm, a top end of the mechanical arm has a plurality of mechanical claws, the mechanical arm is capable of picking up the textile article main part by means of the plurality of mechanical claws, the mechanical claws take the textile article main part to a place below the spectrum identification module or in an accommodation space inside the reflective concentrator, thereby performing identification on the textile article main part, after completing identification, the mechanical arm subsequently places the textile article main part to the predetermined storage position.

17. The smart device with optical dual-mode sensing module array of claim 16, wherein the conveyor module comprises a conveyor belt, the textile article main part is transported on a conveyor surface of the conveyor belt along a conveying direction of the conveyor belt; a quantity of the at least one sensing selection module is plural, and the plurality of sensing selection modules are intervally provided on an upper side of the conveyor belt along the conveying direction of the conveyor belt.

18. The smart device with optical dual-mode sensing module array of claim 17, wherein in each of the spectrum identification modules, quantities of the at least one light source, the at least one optical probe and the at least one optical fiber are respectively plural, each of the optical fibers is correspondingly connected to one of the optical probes, the plurality of optical probes are intervally provided from each other and are located on an inner surface of the reflective concentrator, the plurality of light sources are intervally provided from each other on the inner surface of the reflective concentrator, none of the light sources on the inner surface of the reflective concentrator overlaps with any of the light sources, and before being connected to the spectrometer, the plurality of optical fibers are firstly integrated into an integrated optical fiber by means of an optical fiber integration module, passed through an optical fiber array switch, and then connected to the spectrometer by using a shared optical fiber.

19. The smart device with optical dual-mode sensing module array of claim 18, wherein the optical fiber array switch comprises a switch switching module and a plurality of optical fiber switches respectively coupled to the switch switching module, a path connected between each of the integrated optical fibers and the spectrometer is connected to one of the optical fiber switches correspondingly, after passing through each of the optical fiber switches, each of the integrated optical fibers is integrated into the shared optical fiber and then connected to the spectrometer, the switch switching module is coupled to the processing module, and the processing module notifies the switch switching module and controls an ON-state or OFF-state of each of the optical fiber switches, the ON-state indicates a light may pass through, and the OFF-state indicates the light may not pass through.

20. The smart device with optical dual-mode sensing module array of claim 15, wherein the selection module comprises a mechanical arm, a swivel base and a plurality of mechanical claws, the mechanical arm is connected to the base and the swivel base is rotatably provided on the base, the plurality of mechanical claws are provided on the swivel base, the image capture element is provided on a lateral portion of the mechanical arm, the mechanical arm is capable of picking up the textile article main part by means of the plurality of mechanical claws, thereby enabling the textile article main part to be located below the spectrum identification module or in an accommodation space inside the reflective concentrator to perform identification on the textile article main part, after completing identification, the mechanical arm subsequently places the textile article main part to the predetermined storage position.
